(19) United States
(12) Patent Application Publication
(10) Pub. No.: US 2005/0231937 A1
(43) Pub. Date: Oct. 20, 2005

(54) Lighted carrier having items stored therein

(76) Inventors: Mary Carol Fitzgerald, Naples, FL (US); Joseph Fasano, Naples, FL (US)

Correspondence Address: Mary Carol Fitzgerald, 2742 14th St. N, Naples, FL, 34103, US

(21) Appl. No.: 10/826,817

(22) Filed: Apr. 19, 2004

(51) Int. Cl. F21V 33/00

(52) U.S. Cl. 362/109

(57) ABSTRACT

A lighted hand carried carrier having items stored therein. The carrier has an open but closeable closure and a closed bottom. a circular string of lights is placed at the closed bottom and is operable by a power source and a switch to illuminate the items stored in the carrier from below. The string of lights can also be placed in the vicinity of the top opening of the carrier to shine downwardly into the items stored therein. An intermediate string of lights can be included in the circular circuit of lights by way of connectors. The carrier can be a conventional handbag or an gattaché case or any other carrier such as a suit case

### CROSS REFERENCE TO RELATED APPLICATIONS

(none)

### STATEMENT REGARDING FED SPONSORED R & D

(none)

### BACKGROUND OF THE INVENTION

The invention is directed to hand-carried items such as a hand bag, a suit case or an attaché case or a back pack. These items have to be opened at certain times to be examined, inspected or simply to find a certain item therein. However, in day light or in darkness it is extremely difficult to locate items because of the darkness within the carrier.

### BRIEF SUMMARY OF THE INVENTION

To overcome the above noted disadvantages, the inventive concept introduces a light system into the above noted carriers to illuminate the interior of the carriers to be able to locate certain items such as keys, wallet, identification or may be a check book or any other item.

The lighting system may be operating in the bottom of the carrier to shine the lighting upwardly or at the opening of the carrier to shine the lighting downwardly. The lighting may also be installed in such a manner so that the lighting shines around the items deposited in the carrier.

### BRIEF DESCRIPTION OF THE DRAWINGS

FIG. 1 shows a handbag having a lighting system installed in the bottom;

FIG. 2 shows the handbag of FIG. 1 with a different arrangement of the lighting system;

FIG. 3 shows the lighting system of FIG. 1 installed in a handbag in a different way.

FIG. 4 shows the lighting system of FIG. 2 installed in a different carrier such as an attaché case.

### DETAILED DESCRIPTION OF THE INVENTION

FIG. 1 shows a handbag 1 having a shoulder 2 to be carried by a person. The bottom of the handbag 1 is indicated at 3. In the bottom 3 of the handbag there is located a string of lights 4 having a cross section of lights 5 which connect to the lights 4 at the intersections 6. When these lights are placed in the bottom of a handbag, for example, the lights will shine upwardly to illuminate items between the bottom of the handbag and the top.

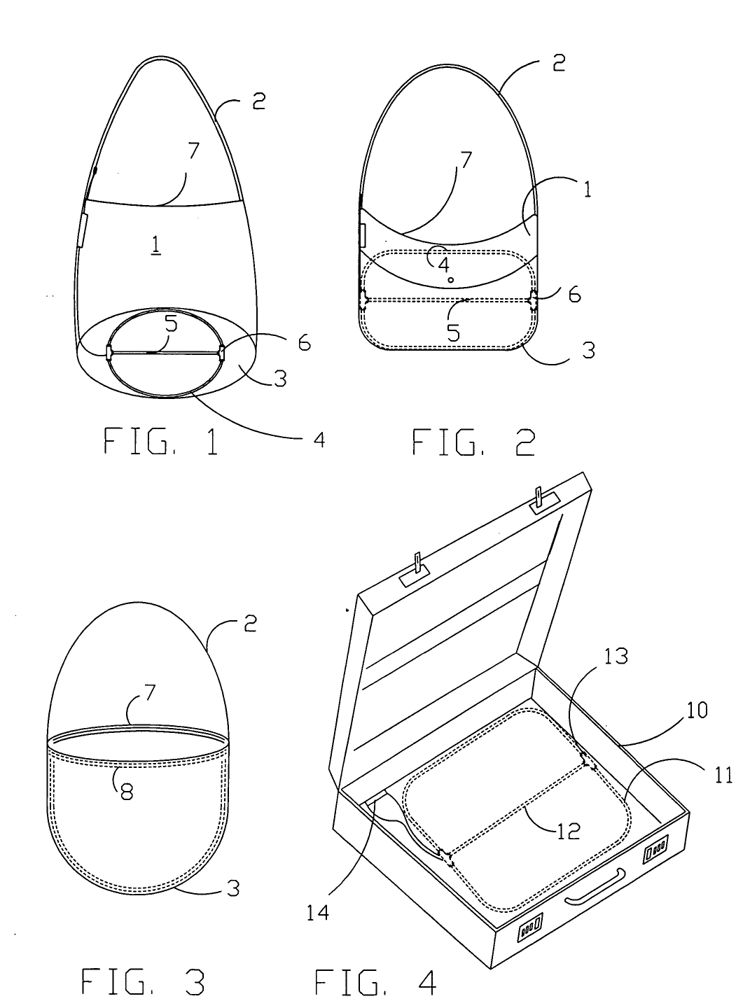

FIG. 2 illustrates basically the same display as shown in FIG. 1 with the difference that the profile in the bottom of the bag is different in that the bottom of the bag 1 is squared off and therefore the circumferential profile of the light strings 4 should more closely follow this outline. Otherwise, the same reference characters are being used as those of FIG. 1.

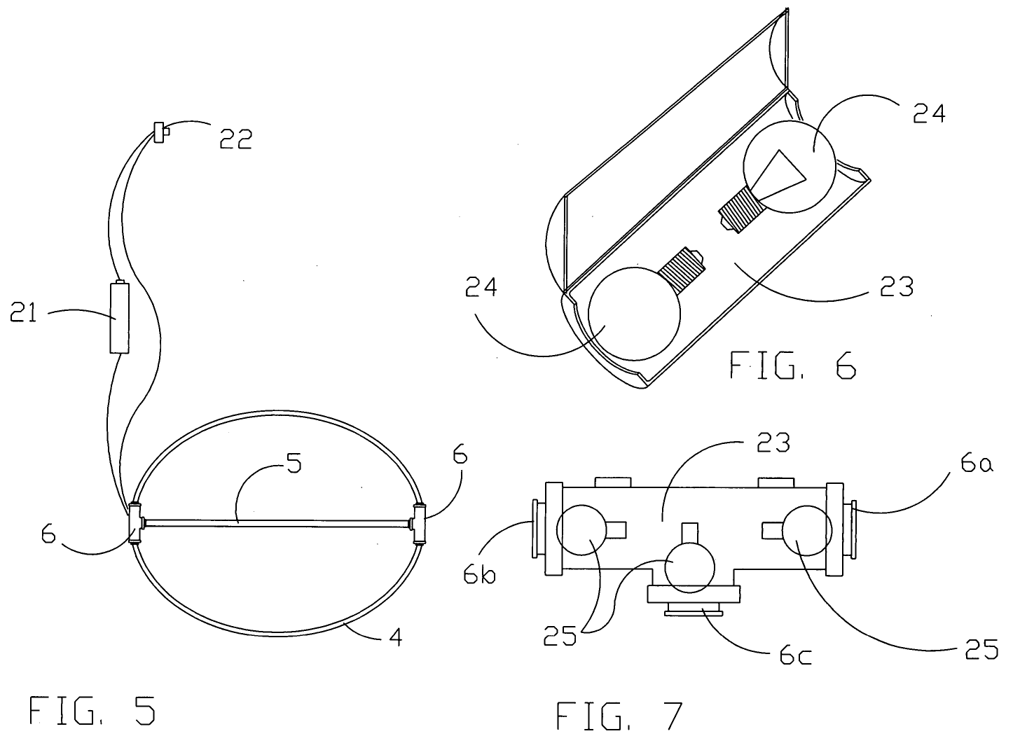

FIG. 3 is still another type of handbag 1 having a wider opening at the top. However, in this handbag the lighting strings 8 are placed at the top of the opening 7 so that the light emanating from the light string shines downwardly into the handbag so that items therein can easily be seen from the top of the handbag

FIG. 4 illustrates a different carrier such as an attaché case 10 which normally has a square or a rectangular configuration. It is normally a rigid case and the light strings 11 can be mounted in the bottom of the case or, of course, in the top part of case, the cover in this case. In the center of the light string 10 there is connector 13 which will connect a center light string 12 to both sides of the circumferential light string 11. There is also shown a light switch 14 which can be activated once the case 10 is open or can also be activated when the clasps are operated.

FIG. 5 illustrates the light system itself without the benefit of any carrier. The light string 4 can be of any configuration, that is, circular, oval or square. There are shown two connectors 6 which will accommodate a center line of lights 5. From one of the connectors 6 wires can be connected including a power source 21 (batteries) to lead from thereon to a light switch 22. The light switch can be placed anywhere within or outside the carrier 1. It could be part of the closure of the handbag or attaché case or the operator of the closures or zippers. FIG. 6 shows the interior of a connector as a casing 23 and having two small light bulbs 24 therein.

FIG. 6 illustrates a typical connector 6 having two lateral outlets and electrical connections for the two lateral connections 6a and 6b to complete a round or square circuit of lights or a lateral connection to a center line 6c of lights. It is also possible to include light bulbs 25 in this connection.

It can be seen that the inventive lighting system as shown and explained above is quite versatile and is extremely useful in the dark when looking for anything in the handbag or any other carrier for items necessary for everyday living such as car keys, house keys or other necessary items.

1. A light system installed in a hand carried carrier having various items stored therein, said carrier having a closeable top opening therein and a closed bottom, said closed bottom having a circuit of strings of lights placed therein to shine upwardly into said stored items therein, a power source to power said strings of light including a switch being included in said circuit, said switch being operable to turn said lights off and on.

2. The light system of claim 1 including another string of lights being placed intermediate said string of lights by way of connectors.

3. The light system of claim 2 including light bulbs placed within said connector.

4. The light system of claim 1 wherein said light system is placed at said opening of said carrier to shine downwardly into said stored items therein.

5. The light system of claim 1, wherein said carrier is a conventional handbag.

6. The light system of claim 1, wherein said carrier is an attaché case.

7. The light system of claim 2, wherein said connector is a three-way connector.
